(19) United States
(12) Patent Application Publication
(10) Pub. No.: US 2010/0251993 A1
(43) Pub. Date: Oct. 7, 2010

(54) BI-FUEL INTERNAL COMBUSTION ENGINE

(75) Inventor: Kazuo Sugiyama, Hamamatsu-shi (JP)

Correspondence Address: MARSH, FISCHMANN & BREYFOGLE LLP, 8055 East Tufts Avenue, Suite 450, Denver, CO, 80237, US

(73) Assignee: SUZUKI MOTOR CORPORATION, Hamamatsu-shi (JP)

(21) Appl. No.: 12/752,925

(22) Filed: Apr. 1, 2010

(30) Foreign Application Priority Data
Apr. 2, 2009 (JP) 2009-090311

(51) Int. Cl. F02B 3/00; F23C 1/08; F02M 61/14

(52) U.S. Cl. 123/299; 123/525; 123/470

(57) ABSTRACT

A bi-fuel internal combustion engine comprises an engine body having a cylinder axis inclined toward one side; a branched intake pipe extending from a cylinder head at an inclined upper face side of the engine body to the other side; liquid fuel injection valves for injecting liquid fuel to the intake pipe; and gas fuel injection valves for injecting a gas fuel to the intake pipe. The liquid fuel injection valves are arranged in the vicinity of the cylinder head at one side of the intake pipe, and the gas fuel injection valves are arranged at an upper side exceeding the highest position of a cylinder head cover mounted on the cylinder head at one side of the liquid fuel injection valves.

### BACKGROUND OF THE INVENTION

The present invention relates to a bi-fuel internal combustion engine and particularly to a bi-fuel internal combustion engine including at least one liquid fuel injection valve for injecting a liquid fuel and at least one gas fuel injection valve for injecting a gas fuel.

As is known, internal combustion engines for vehicles or the like can be classified firstly as the type which use liquid fuel such as gasoline, secondly as the type which use gas fuel such as natural gas (CNG), and thirdly as the type known as “bi-fuel internal combustion engines” which use two kinds of fuels, namely, liquid fuel and gas fuel. By switching liquid fuel to/from gas fuel according to operating condition, the bi-fuel internal combustion engine can satisfy traveling performance requirements when using liquid fuel and hazardous components contained in exhaust gases can be reduced when using gas fuel.

The conventional bi-fuel internal combustion engine comprises an engine body having a cylinder axis inclined toward one side, an intake pipe extending from a cylinder head at an inclined upper face side of the engine body to the other side, at least one liquid fuel injection valve mounted on the intake pipe and adapted to inject a liquid fuel, and at least one gas fuel injection valve mounted on the intake pipe and adapted to inject a gas fuel. The liquid fuel injection valve is arranged in the vicinity of the cylinder head at an upper side of the intake pipe, and the gas liquid injection valve is arranged on an intake upstream side of the liquid fuel injection valve at a lower side of the intake pipe. Owing to the foregoing arrangement, it is possible to arrange the gas fuel injection valve in a dead space at a lower side of the intake pipe so that the total height of the internal combustion engine can be reduced and a compact size of the internal combustion engine can be achieved.

Related Art to the present invention is described in Official Gazette of Japanese Patent Application Laid-Open Specification No. 2004-36482. While the bi-fuel internal combustion engine disclosed in that specification provides the advantage of making the internal combustion engine compact because the gas fuel injection valve is arranged at a lower side of the intake pipe, it nevertheless suffers from the problem that the intake pipe located at the upper side disturbs operation when maintenance operations for the gas fuel injection valve are being conducted. Moreover, since it is necessary to secure a space for mounting the gas injection valve at a lower side of the intake pipe, the degree of freedom when determining the arrangement of the intake pipe is limited.

Furthermore, the bi-fuel internal combustion engine disclosed in Japanese Patent Application Laid-Open Specification No. 2004-36482 suffers from an additional problem of noise generated due to propagation of operating noise and vibrations from the gas fuel injection valve as a result of the gas fuel injection valve being mounted directly to the intake pipe. Consequently, the degree of freedom for selecting the mounting position of the gas fuel injection valve is limited.

It is therefore the object of this invention to provide a bi-fuel internal combustion engine capable of enhancing the maintenance performance of the gas fuel injection valve while achieving a compact size for the bi-fuel internal combustion engine with the possibility of enhancing the degree of freedom in determining the arrangement of the intake pipe by securing a space at a lower side of the intake pipe.

### SUMMARY OF THE INVENTION

The present invention provides a bi-fuel internal combustion engine comprising an engine body having a cylinder axis inclined toward one side; an intake pipe extending from a cylinder head at an inclined upper face side of the engine body to the other side; at least one liquid fuel injection valve for injecting a liquid fuel to the intake pipe; and at least one gas fuel injection valve for injecting a gas fuel to the intake pipe: wherein the at least one liquid fuel injection valve is arranged in the vicinity of the cylinder head at one side of the intake pipe, and the at least one gas fuel injection valve is arranged at an upper side exceeding the highest position of a cylinder head cover mounted on the cylinder head at one side of the at least one liquid fuel injection valve

Preferably, the at least one gas fuel injection valve is mounted on the cylinder head cover through a vibration absorbing member.

In the bi-fuel internal combustion engine of the present invention, the gas fuel injection valve is arranged at an upper side exceeding the highest position of the cylinder head cover. Accordingly, the gas fuel injection valve can be arranged in a position where operation can easily be conducted, and thus, maintenance performance of the gas fuel injection valve can be enhanced while achieving a compact size of the bi-fuel internal combustion engine.

Moreover, in this bi-fuel internal combustion engine, the gas fuel injection valve is mounted at a lower side of the intake pipe unlike the conventional arrangement. Accordingly, extra space can be secured as it is no longer necessary to provide a space for mounting the gas fuel injection valve at a lower side of the intake valve and thus, the degree of freedom in determining the arrangement of the intake pipe can be enhanced.

### BRIEF DESCRIPTION OF THE DRAWINGS

FIG. 1 is a perspective view of a cylinder head part of a bi-fuel internal combustion engine.

FIG. 2 is a side view of a gas fuel injection valve when viewed in a direction as indicated by an arrow II of FIG. 1.

FIG. 3 is a perspective view showing an assembled state of the gas fuel injection valve.

FIG. 4 is a plan view of the bi-fuel internal combustion engine.

FIG. 5 is a front view of the bi-fuel internal combustion engine.

FIG. 6 is a side view of the bi-fuel internal combustion engine.

FIG. 7 is a diagrammatic plan view of a vehicle on which the bi-fuel internal combustion engine is installed.

### DETAILED DESCRIPTION OF A PREFERRED EMBODIMENT

In the present invention, a gas fuel injection valve is arranged at an upper side exceeding the highest position of a cylinder head cover. Accordingly, maintenance performance of the gas fuel injection valve can be enhanced and the degree of freedom in determining the arrangement of an intake pipe can be enhanced while achieving a compact size of the bi-fuel internal combustion engine.

One embodiment of the present invention will be described hereinafter with reference to the drawings.

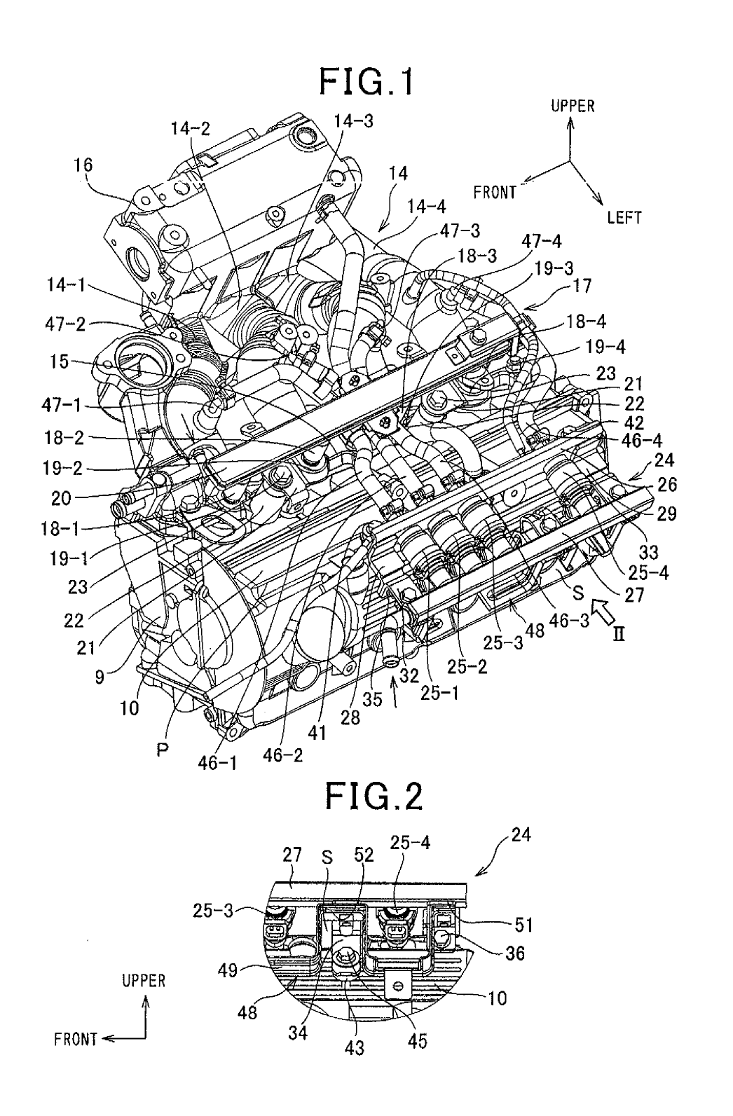

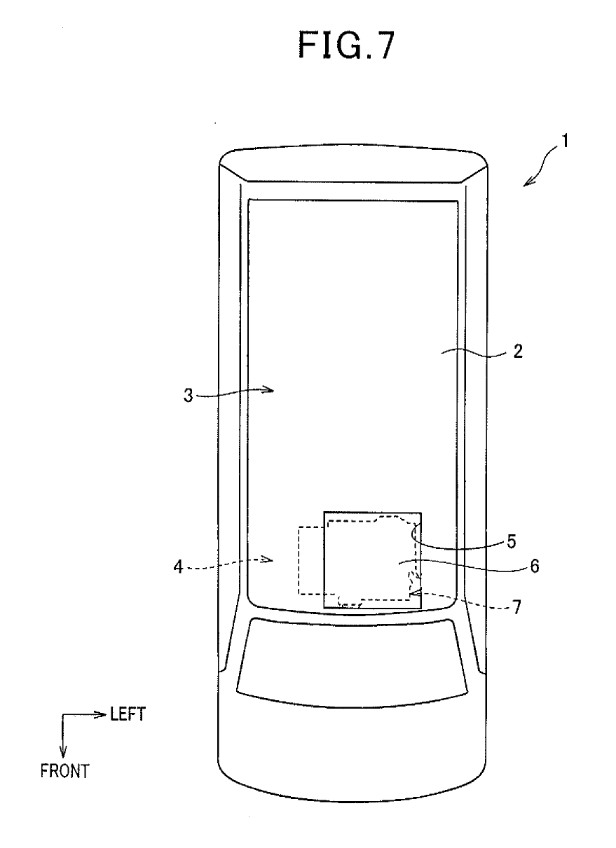

FIGS. 1 through 7 show one embodiment of the present invention. In FIG. 7, reference numeral 1 denotes a vehicle. The vehicle 1 has a passenger compartment 3 on an upper side of a floor panel 2 and an engine compartment 4 on a lower side of the floor panel 2. The floor panel 2 on the upper side of the engine compartment 4 is provided with an opening 5 for gaining access. The opening 5 is openably/closably covered with a cover panel 6. A bi-fuel internal combustion engine 7 is mounted in the engine compartment 4.

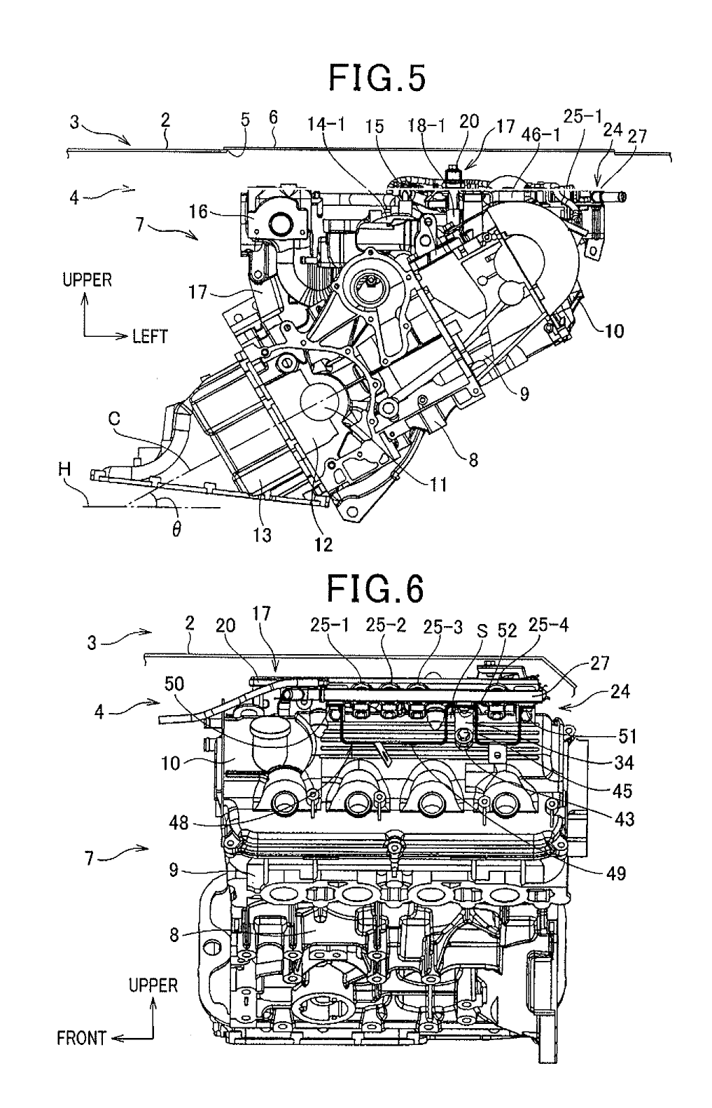

In the bi-fuel internal combustion engine 7, as shown in FIGS. 4 through 6, a cylinder head 9 is mounted on an upper part of a cylinder block 8 serving as an engine body, a cylinder head cover 10 is mounted on the cylinder head 9, and an oil pan 13 is mounted on a lower part of the cylinder block 9 with a crankshaft 12 supported on a crank lower case 11. The bi-fuel internal combustion engine 7 is mounted in the engine compartment 4 such that, as shown in FIG. 5, the cylinder axis C of the cylinder block 9 serving as the engine body is inclined by a predetermined angle θ with respect to the horizontal line H so as to extend in the upper left direction at one side of the vehicle.

The bi-fuel internal combustion engine 7 has an intake manifold 14 which includes first through fourth intake branch pipes 14-1 through 14-4 which constitute an intake pipe. The first through fourth intake branch pipes 14-1 through 14-4 are sequentially arranged at an inclined upper face of the cylinder block 8 from the front side of the vehicle toward its rear side. The respective downstream sides of the first through forth intake branch pipes 14-1 through 14-4 in the air flow direction are mounted on one side of an inclined upper face (intake side) of the cylinder head 9 in the left-hand direction of the vehicle by a mounting flange 15, and the respective upstream sides of the branch pipes 14-1 through 14-4 in the air flow direction are allowed to extend toward the other side of an inclined upper face of the cylinder block 8 in a right-hand direction of the vehicle and connected to a lower part of a surge tank 16.

The surge tank 16 is formed in a quadrangular cylindrical configuration with its major axis in the front-rear direction of the vehicle. The longitudinal surge tank 16 is arranged such that it extends in the front-rear direction of the vehicle at an upper part of a lower part of the cylinder block 8, it being slightly offset toward a rear side from the center of the cylinder block 8 in the front-rear direction of the vehicle. The surge tank 16 is mounted on an upper part of the lower part of the cylinder block 8 by a tank mounting bracket 17. The upstream side of the surge tank 8 on the front side of the vehicle is connected with a throttle body.

The first through fourth intake branch pipes 14-1 through 14-4 of the intake manifold 14 are curved such that the branch pipes 14-1 through 14-4 extend diagonally downward from the above-mentioned one side in the left-hand direction of the vehicle, in other words, from the mounting flange 15 by which the pipes 14-1 through 14-4 are mounted on the inclined upper face of the cylinder head 9 toward the other side in the right-hand direction of the vehicle, in other words, toward the rear side of the vehicle along the inclined upper face of the cylinder block 8 and then extend upward so as to be connected to a lower part of the surge tank 16. Owing to the foregoing arrangement, the pipe length of each of the first through fourth intake branch pipes 14-1 through 14-4 of the bi-fuel internal combustion engine 7 can be increased.

In the bi-fuel internal, combustion engine 7, the inclined lower face side (exhaust side) of the cylinder block 9 is connected with first through fourth exhaust branch pipes of an exhaust manifold which constitute an exhaust pipe. The first through fourth exhaust branch pipes are converged and connected to a catalytic converter.

The bi-fuel internal combustion engine 7 includes a liquid fuel injection apparatus 17. The liquid fuel injection apparatus 17, as shown in FIG. 1, includes first through fourth liquid fuel injection valves 18-1 through 18-4 for injecting liquid fuel to the first through fourth intake branch pipes 14-1 through 14-4 of the intake manifold 14. The first through fourth liquid fuel injection valves 18-1 through 18-4 are arranged at one side of the first through fourth intake branch pipes 14-1 through 14-4 in the left-hand direction of the vehicle and at an upper side in the vicinity of the cylinder head 9 The first through fourth liquid fuel injection valves 18-1 through 18-4 are sequentially arranged at equal intervals from the front side of the cylinder head 9 toward its rear side with respect to the vehicle, with fuel injecting distal ends of the injection valves 18-1 through 18-4 directed downwardly of the vehicle. The distal ends of the first through fourth fuel liquid injection valves 18-1 through 18-4 are mounted on corresponding first through fourth liquid fuel injection valve mounting parts 19-1 through 19-4 disposed at an upper side of the first through fourth intake branch pipes 14-1 through 14-4 which are located in the vicinity of the cylinder head 9, so that liquid fuel can be injected to corresponding intake passages of the first through fourth intake branch pipes 14-1 through 14-4.

The fuel intake basal ends of the first through fourth liquid fuel injection valves 18-1 through 18-4 are connected to a liquid fuel delivery pipe 20. The liquid fuel delivery pipe 20 is formed in an elongated quadrangular cylindrical configuration with its major axis in the rear direction of the vehicle, and the end of the delivery pipe 20 in the longitudinal direction is oriented in the front-rear direction of the vehicle at an upper part of the mounting flange 15. A liquid fuel pipe fixture 21 of the liquid fuel delivery pipe 20 is fixed to a liquid fuel pipe fixing part 22 by a fixing bolt 23 which is disposed at the mounting flange 15. The liquid fuel delivery pipe 20 is adapted to control the pressure of the liquid fuel supplied from a liquid fuel supply pipe and distribute and supply the pressure-controlled liquid fuel to the first through fourth liquid fuel injection valves 18-1 through 18-4.

The bi-fuel internal combustion engine 7 further includes a gas fuel injection apparatus 24. The gas fuel injection apparatus 24 includes, as shown in FIGS. 1 through 3, first through fourth gas fuel injection valves 25-1 through 25-4 adapted to inject gas fuel to the corresponding first through fourth intake branch pipes 14-1 through 14-4 of the intake manifold 14.

The first through fourth gas fuel injection valves 25-1 through 25-4 each have a cylindrical body which is disposed horizontally. The fuel injecting distal ends of the injection valves 25-1 through 25-4 are directed to the other side in the right-hand direction of the vehicle. The first through third gas injection valves 25-1 through 25-3 are sequentially arranged at equal spacings in mutually proximate relation from the generally central area of the vehicle toward its rear side. The fourth gas injection valve 25-4 is spaced apart from the third gas injection valve 25-3 with a space S therebetween. The distal ends of the first through fourth gas injection valves 25-1 through 25-4 are mounted on a gas fuel injection valve mounting bracket 26, and the fuel intake basal ends thereof are connected to a gas fuel delivery pipe 27. The gas fuel delivery pipe 27 is adapted to control the pressure of the gas fuel supplied from a gas fuel supply pipe and distribute and supply the pressure-controlled gas fuel to the first through fourth gas fuel injection valves 25-1 through 25-4.

The gas fuel injection valve mounting bracket 26 is formed in an elongated plate-like configuration with its major axis in the front-rear direction of the vehicle. The mounting bracket 26 is provided with bracket side connecting parts 28, 29 at the inner side of its both ends opposite to the gas fuel delivery pipe 27 and with bracket side mounting parts 30, 31 at the outer side of both ends thereof. The gas fuel delivery pipe 27 is formed in an elongated quadrangular cylindrical configuration with its major axis in the front-rear direction of the vehicle. The delivery pipe 27 is provided with pipe side connecting parts 32, 33 at the inner side of its both ends opposite to the mounting bracket 26 and with a pipe side mounting part 34 (see FIG. 2) between the intermediate third gas fuel injection valve 25-3 and the fourth gas fuel injection valve 25-4. The mounting bracket 26 and the delivery pipe 27 are integrally connected to each other by fixing two units of the opposing bracket side connecting members 28, 29 and pipe side connecting members 32, 33 at both ends of their inner sides with fixing bolts 35, 36, thereby supporting the distal ends and the basal ends of the first through fourth gas fuel injection valves 25-1 through 25-4, respectively.

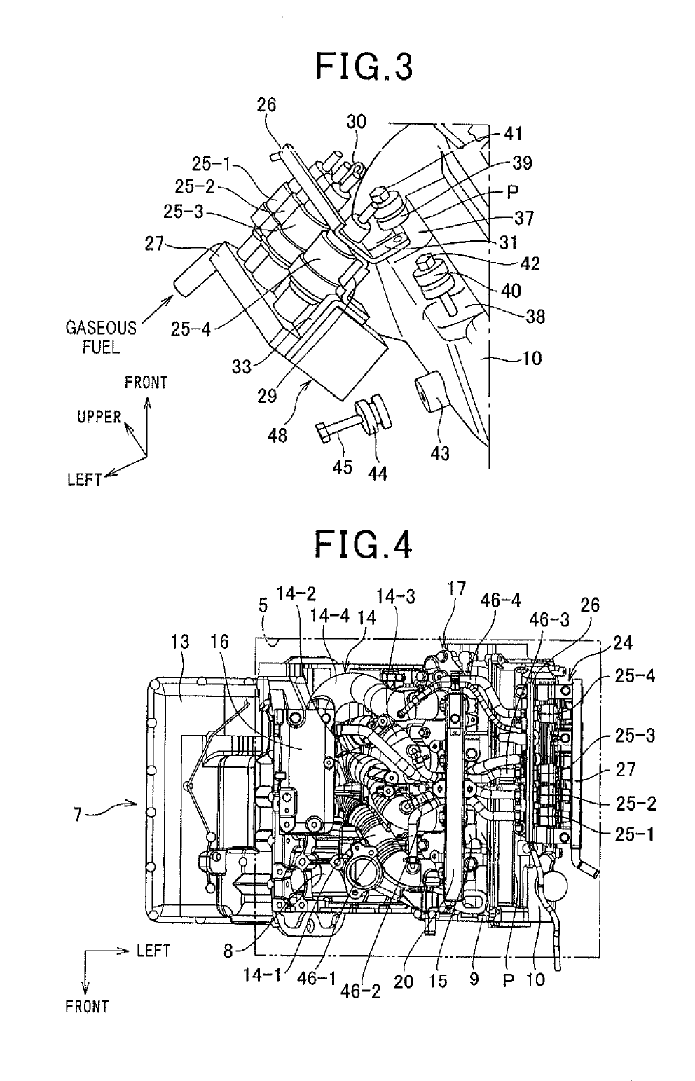

The gas fuel injection valve mounting bracket 26 and the gas fuel delivery pipe 27 which support the first through fourth gas fuel injection valves 25-1 through 25-4 are mounted on the cylinder head cover 10 such that as shown in FIGS. 2 and 3, the two bracket side mounting parts 30, 31 are mounted to two bracket mounting parts 37, 38 at a first one side of the highest position P of the cylinder head cover 10 in the left-hand direction of the vehicle by bracket mounting bolts 41, 42 through vibration absorbing members 39, 40, and a single number of the above-mentioned pipe side mounting part 34 is mounted to a pipe mounting part 43 at a second one side of and further away from the highest position P of the cylinder head cover 10 in the left-hand direction of the vehicle by a pipe mounting bolt 45 through a vibration absorbing member 44.

Owing to the above-mentioned arrangement, the first through four gas fuel injection valves 25-1 through 25-4 are arranged at one side of the first through fourth liquid fuel jetting valves 18-1 through 18-4 in the left-hand direction of the vehicle and at an upper side exceeding the highest position P of the cylinder head cover 10.

Since the first through fourth gas fuel injection valves 25-1 through 25-4 of the bi-fuel internal combustion engine 7 are horizontally arranged in a parallel relationship to one another at an upper side exceeding the highest position P of the cylinder head cover 10, the injection valves 25-1 through 25-4 can be arranged in a position where an inspection operation can be performed easily without increasing the total height of the bi-fuel internal combustion engine 7.

By virtue of the above-mentioned arrangement, the bi-fuel internal combustion engine 7 is advantageous in that easy access can be obtained to the first through fourth gas fuel injection valves 25-1 through 25-4 which are arranged at an upper side of the cylinder head cover 10 in the engine compartment 4 without the need to open the cover panel 6 of the opening 5, while achieving a compact size of the bi-fuel internal combustion engine 7, and maintenance performance of the first through fourth gas fuel injection valves 25-1 through 25-4 can be enhanced.

Moreover, since the first through fourth gas fuel injection valves 25-1 through 25-4 of the bi-fuel internal combustion engine 7 are not mounted on a lower side of the first through fourth intake branch pipes 14-1 through 14-4 of the intake manifold 14 unlike the conventional valves, it is no longer necessary to secure a space for mounting the first through fourth gas fuel injection valves 25-1 through 25-4 at a lower side of the first through fourth intake branch pipes 14-1 through 14-4 and the degree of freedom in determining the arrangement of the first through fourth intake gas fuel injection valves 25-1 through 25-4 can be enhanced.

By virtue of the above-mentioned features, the pipe length of the first through fourth intake branch pipes 14-1 through 14-4 can be increased by curving the branch pipes 14-1 through 14-4 in the upward-downward direction within the above-mentioned space. Thus, the bi-fuel internal combustion engine 7 can enhance the engine performance.

Moreover, since the first through fourth gas fuel injection valves 25-1 through 25-4 of this bi-fuel internal combustion engine 7 are mounted on the cylinder head cover 10 through the vibration absorbing members 39, 40 and 44, the emission of operating noise and the propagation of vibrations caused by the first through fourth gas fuel injection valves 25-1 through 25-4 can be suppressed and the generation of noise can be reduced.

The distal ends of the first through fourth gas fuel injection valves 25-1 through 25-4 which are arranged at an upper side exceeding the highest position P of the cylinder head cover 10 are connected to corresponding one ends of first through fourth gas fuel hoses 46-1 through 46-4. The other ends of the first through fourth gas fuel hoses 46-1 through 46-4 are connected to corresponding first through fourth hose mounting parts 47-1 through 47-4 which are disposed midway of the first through fourth intake branch pipes 14-1 through 14-4 of the intake manifold 14. The first through fourth gas fuel injection valves 25-1 through 25-4 are adapted to inject gas fuel to the corresponding intake passages of the first through fourth intake branch pipes 14-1 through 14-4 through the first through fourth gas fuel hoses 46-1 through 46-4.

Since the first through fourth gas fuel injection valves 25-1 through 25-4 of the bi-fuel internal combustion engine 7 are connected to the corresponding first through fourth intake branch pipes 14-1 through 14-4 through the corresponding first through fourth gas fuel hoses 46-1 through 46-4, the degree of freedom in setting the mounting position of the first through fourth gas fuel injection valves 25-1 through 25-4 can be enhanced and a compact size of the gas fuel supply apparatus 24 can be achieved.

The gas fuel delivery pipe 27, as shown in FIGS. 2 and 6, is mounted with a heat shielding plate 48 adapted to cover a lower side of the first through fourth gas fuel injection valves 25-1 through 25-4. The heat shielding plate 48 comprises an elongated plate-shaped heat shielding part 49 for covering a lower side of the first through fourth gas fuel injection valves 25-1 through 25-4, end mounting parts 50, 51 raised from the both ends of the shielding part 49 and mounted on the gas fuel delivery pipe 27 and an intermediate mounting part 52 raised from the middle of the shielding part 49 and mounted on the gas fuel delivery pipe 27 in the space S between the third gas fuel injection valve 25-3 and the fourth gas fuel injection valve 25-4. The heat shielding part 48 is formed in a generally W-shaped configuration.

The heat shielding plate 48 is disposed between (A) the exhaust manifold and the catalytic converter which constitute the exhaust pipe connected to an inclined lower face side (exhaust side) of the cylinder head 9 and, (B) the first through fourth gas fuel injection valves 25-1 through 25-4 which are disposed at an upper part of the exhaust manifold and catalytic converter, and adapted to shield against heat.

Since the bi-fuel internal combustion engine 7 is provided with the heat shielding plate 48 for covering a lower side of the first through fourth gas fuel injection valves 25-1 through 25-4, the injection valves 25-1 through 25-4 are not exposed to exhaust heat, the variation in jetting quantity of gas fuel caused by heat can be restrained and the jetting quantity of gas fuel can be stabilized. A PCV hose for blowby gas is inserted in the space S between the third gas fuel injection valves 25-3 and the fourth gas fuel injection valve 25-4.

The present invention is capable of enhancing the maintenance performance of the gas fuel injection valve and enhancing the degree of freedom in determining the arrangement of the intake pipe while achieving a compact size of the bi-fuel internal combustion engine, and it is applicable not only to bi-fuel internal combustion engines but also to those other internal combustion engines having a gas fuel injection valve only.

### LIST OF MAIN REFERENCE NUMERALS

1 Vehicle
7 Bi-fuel internal combustion engine
8 Cylinder block
9 Cylinder head
10 Cylinder head cover
14 Intake manifold
14-1 to 14-4 First through fourth intake branch pipes
17 Liquid fuel injection apparatus
18-1 to 18-4 First through fourth liquid fuel injection valves
20 Liquid fuel delivery pipe
24 Gas fuel injection apparatus
25-1 to 25-4 First through fourth gas fuel injection valves
26 Gas fuel injection valve mounting bracket
27 Gas fuel delivery pipe
30, 31 Bracket side mounting parts
34 Pipe side mounting part
37, 38 Bracket mounting parts
39, 40 Vibration absorbing members
41, 42 Bracket mounting bolts
43 Pipe mounting part
44 Vibration absorbing member
45 Pipe mounting bolt
46-1 to 46-4 First through fourth gas fuel hoses
48 Heat shielding plate.

1. A bi-fuel internal combustion engine comprising an engine body having a cylinder axis inclined toward one side; an intake pipe extending from a cylinder head at an inclined upper face side of said engine body to the other side; at least one liquid fuel injection valve for injecting a liquid fuel to said intake pipe; and at least one gas fuel injection valve for injecting a gas fuel to said intake pipe:
wherein said at least one liquid fuel injection valve is arranged in the vicinity of said cylinder head at one side of said intake pipe, and said at least one gas fuel injection valve is arranged at an upper side exceeding the highest position of a cylinder head cover mounted on said cylinder head at one side of said at least one liquid fuel injection valve.

2. The internal combustion engine of claim 1, wherein said at least one gas fuel injection valve is mounted on said cylinder head cover through a vibration absorbing member.

3. The internal combustion engine of claim 1, wherein said at least one gas fuel injection valve is connected to said intake pipe through a gas fuel hose.

4. The internal combustion engine of claim 2, wherein said at least one gas fuel injection valve is connected to said intake pipe through a gas fuel hose.
